(19) United States
(12) Patent Application Publication
(10) Pub. No.: US 2026/0055648 A1
(43) Pub. Date: Feb. 26, 2026

(54) Handle Device and Vehicle

(71) Applicant: Illinois Tool Works Inc., Glenview, IL (US)

(72) Inventor: Penghui Yi, Shanghai (CN)

(21) Appl. No.: 19/306,616

(22) Filed: Aug. 21, 2025

(30) Foreign Application Priority Data
Aug. 22, 2024 (CN) 202411156669.X
Aug. 14, 2025 (CN) 202511136286.0

(51) Int. Cl. E05B 85/10; E05B 85/16

(52) U.S. Cl. CPC E05B 85/107; E05B 85/16

(57) ABSTRACT

A handle device that includes a handle base, a handle, and first and second pushing members. The handle has a main body and an operating member that extends from it. The handle is attached to the base so it can rotate around an axis, allowing it to move between a retracted position, a deployed position, and an intermediate position. The first pushing member can move toward and away from the handle body in a first direction. The second pushing member moves forward and backward in a second direction using a driving device and has front and rear actuating portions. The front portion is farther from the axis than the rear portion. When the second pushing member moves forward, the front portion pushes the first pushing member, which rotates the handle from the retracted position to the intermediate position. Then, the rear portion engages with the handle's operating member to rotate the handle from the intermediate position to the deployed position.

### RELATED APPLICATIONS

The present application claims the benefit of Chinese Patent Application Nos. 202411156669.X, filed Aug. 22, 2024, and 202511136286.0, filed Aug. 14, 2025, each titled “Handle Device and Vehicle,” the contents of which are hereby incorporated by reference.

### TECHNICAL FIELD

The present disclosure relates to a handle device, and in particular to a handle device for a vehicle and a vehicle including the handle device.

### BACKGROUND

In the prior art, for a vehicle having a flush or retractable handle, when it is necessary to unlock and open a door, the handle shall be deployed from a retracted position to a deployed position before an operator can operate the handle to unlock and open the door. However, when cold weather is encountered, an outer surface of the vehicle may be covered with a layer of ice due to rain or snow, resulting in that the handle is frozen to the outer surface of the vehicle, and cannot be deployed normally from the retracted position.

### SUMMARY

The present disclosure relates generally to a handle device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a schematic view of a vehicle using a handle device according to the present disclosure.

FIG. 1B is a perspective view of a handle device according to an embodiment of the present disclosure.

FIG. 1C is a perspective view of the handle device shown in FIG. 1B from another perspective.

FIG. 1D is an exploded view of the handle device shown in FIG. 1C.

FIG. 2 is a perspective view of a handle of the handle device shown in FIG. 1C.

FIG. 3 is a perspective view of a first pushing member of the handle device shown in FIG. 1C.

FIG. 4 is a perspective view of a second pushing member of the handle device shown in FIG. 1C.

FIG. 5A is a side view of the handle device shown in FIG. 1C when the handle is in a retracted position, with a portion of a handle base cut away.

FIG. 5B is a side view of the handle device shown in FIG. 1C when the handle is in an intermediate position, with a portion of the handle base cut away.

FIG. 5C is a side view of the handle device shown in FIG. 1C when the handle is in a deployed position, with a portion of the handle base cut away.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a handle device including a handle that is retracted and deployed by rotation. The handle device of the present disclosure breaks ice when the handle is frozen, so that the handle can be rotated to a deployed position.

To at least partially solve the above problem, according to a first aspect of the present disclosure, the present disclosure provides a handle device, which includes a handle base, a handle, a first pushing member and a second pushing member. The handle includes a handle body and a handle operating member extending from the handle body. The handle is rotatably connected to the handle base about an axis so as to switch between a retracted position, a deployed position, and an intermediate position between the retracted position and the deployed position. The first pushing member is movable toward and away from the handle body in a first direction. The second pushing member is configured to move forward and backward in a second direction under the drive of a driving device. The second pushing member includes a front actuating portion and a rear actuating portion. The front actuating portion is further away from the axis than the rear actuating portion. The second pushing member is configured such that during a forward movement in the second direction, the second pushing member operatively engages with the first pushing member through the front actuating portion so as to drive the handle to rotate from the retracted position to the intermediate position by means of the first pushing member, and operatively engages with the handle operating member through the rear actuating portion so as to drive the handle to rotate from the intermediate position to the deployed position by means of the handle operating member.

In some embodiments, the second pushing member includes a front support surface and a rear support surface respectively positioned before and behind the front actuating portion in the second direction. The first pushing member is supported by the front support surface when the handle is in its retracted position, and the first pushing member is supported by the rear support surface when the handle is in its deployed position.

In some embodiments, the front actuating portion and the first pushing member cooperate with each other by means of inclined surfaces such that the front actuating portion operatively engages with the first pushing member.

In some embodiments, the front actuating portion is raised relative to the front support surface and the rear support surface and includes a first front actuating surface and a second front actuating surface respectively connected to the front support surface and the rear support surface. The first front actuating surface and the second front actuating surface extend obliquely relative to the second direction and are inclined oppositely to each other.

In some embodiments, the first pushing member includes a first front actuated surface and a second front actuated surface. The first front actuated surface and the second front actuated surface extend obliquely relative to the second direction and are inclined oppositely to each other. The first front actuated surface cooperates with the first front actuating surface such that the second pushing member is capable of driving the first pushing member to move toward the handle body when moving forward in the second direction. The second front actuated surface cooperates with the second front actuating surface such that the second pushing member is capable of driving the first pushing member to move toward the handle body when moving backward in the second direction.

In some embodiments, the rear actuating portion and the handle operating member cooperate with each other by means of inclined surfaces such that the rear actuating portion operatively engages with the handle operating member.

In some embodiments, the rear actuating portion includes a rear actuating surface, and the handle operating member includes a rear actuated surface. The rear actuating surface and the rear actuated surface extend obliquely relative to the second direction. The rear actuating surface cooperates with the rear actuated surface such that the second pushing member is capable of driving the handle operating member to rotate when moving forward in the second direction.

In some embodiments, the handle base includes an operation cavity, the handle body is at least partially received in the operation cavity, and the handle operating member extends to the outside of the operation cavity. The second pushing member is located outside the operation cavity, the first pushing member is configured to enter the operation cavity when moving toward the handle body, and to move out of the operation cavity when the handle reaches the deployed position.

In some embodiments, the handle base is provided with a guide structure, and the first pushing member is guided by the guide structure to move in the first direction.

In some embodiments, the guide structure comprises a guide sleeve positioned outside the operation cavity, and the first pushing member is at least partially accommodated in the guide sleeve and is guided in a form-fit manner with the guide sleeve.

In some embodiments, the first pushing member is provided with a limiting surface, and the limiting surface is configured to cooperate with the handle base to limit a distance by which the first pushing member moves toward the handle body.

In some embodiments, the handle device further includes a return spring configured to bias the first pushing member in a direction away from the handle body.

In some embodiments, the first pushing member is provided with a retaining surface, and the retaining surface is configured to cooperate with the handle base to retain the return spring between the retaining surface and the handle base.

In some embodiments, the second direction is perpendicular to the first direction.

According to a second aspect of the present disclosure, the present disclosure provides a handle device including the aforementioned handle device.

In the present disclosure, by providing the first pushing member pushed by the second pushing member and having the first pushing member act on the handle at a position farther from its axis, the handle can be pushed to break ice with a relatively small force, to separate the distal end of the handle from the outer surface of the door. In this way, given a constant power of the driving device used, the handle device of the present disclosure can more easily achieve the ice breaking operation. In addition, by being providing with two pushing members cooperating with each other, the handle device of the present disclosure has a relatively high force transmission efficiency during the ice breaking operation, thereby facilitating the ice breaking operation. In addition, the handle device of the present disclosure can perform the operation of deploying the handle by pushing the handle operating member near the axis of the handle only after performing the ice breaking operation, so that it is possible to reduce the additional consumption of power of the driving device during the ice breaking operation, thereby further making the ice breaking operation easier.

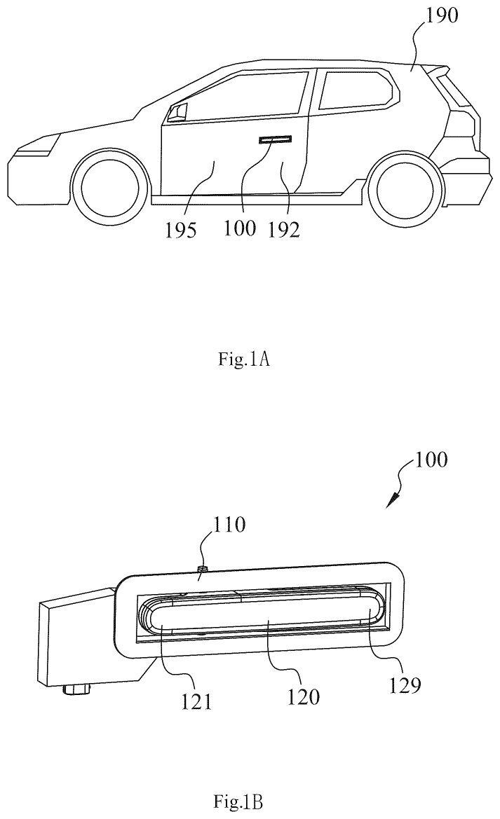

FIGS. 1A-1D show the overall structure of a handle device 100 according to an embodiment of the present disclosure and its usage state. FIG. 1A is a schematic view of a vehicle using the handle device 100, FIGS. 1B and 1C are perspective views of the handle device 100 from two different perspectives, and FIG. 1D is an exploded view of the handle device 100.

As shown in FIG. 1A, the vehicle 190 includes a door 192. The door 192 includes an outer surface 195. The handle device 100 is mounted on the door 192 for unlocking and opening the door 192.

As shown in FIG. 1B, the handle device 100 includes a handle base 110 and a handle 120. The handle 120 is rotatably connected to the handle base 110. The handle 120 has a retracted position corresponding to its rest position and a deployed position corresponding to its ready position, and can be switched between the retracted position and the deployed position by rotation relative to the handle base 110. The handle 120 has a proximal end 121 and a distal end 129.

As shown in FIGS. 1A and 1B, when the handle 120 of the handle device 100 is in its retracted position, an outer surface of the handle 120 is substantially flush with the outer surface 195 of the door 192 of the vehicle 190, and the distal end 129 of the handle 120 does not extend beyond the outer surface 195 of the door, so that an operator cannot grasp the handle 120. In the deployed position, the handle 120 is rotated outwardly relative to the handle base 110 and at least its distal end 129 extends outwardly beyond the outer surface 195 of the vehicle door so that the operator can grasp the handle 120, for subsequent operations such as unlocking and opening the door.

Since the handle 120 in the retracted position is in a substantially flush condition with the outer surface 195 of the door, it is not possible to prevent the handle 120 from being frozen to the outer surface 195 of the door at low temperatures (e.g., in winter). In order to ensure that the handle 120 can be deployed by breaking ice, the handle 120 of the handle device 100 of the present disclosure also has an intermediate position between the retracted position and the deployed position. The handle 120 in the intermediate position is also outwardly deployed relative to the retracted position, but to a much lesser extent than the handle 120 in the deployed position, only slightly outwardly at its distal end 129. In the handle device 100 of the present disclosure, the process of rotating the handle 120 from the retracted position to the intermediate position to perform a preliminary separation of the handle 120 from the outer surface 195 of the door is considered an ice breaking operation.

As shown in FIGS. 1C and 1D, in addition to the handle base 110 and the handle 120, the handle device 100 includes a first pushing member 130, a second pushing member 140, a return spring 160, a shaft 170 and a driving device 180. The handle 120 is connected to the handle base 110 via the shaft 170 and can rotate about an axis A between the retracted position, the intermediate position and the deployed position relative to the handle base 110.

The handle 120 includes a handle body 125 and a handle operating member 122 extending from the handle body 125 (see FIG. 1C). The handle operating member 122 is located between the proximal end 121 and the distal end 129 and is located on an inner side of the handle body 125.

The handle base 110 has an operation cavity 115, the handle body 125 is received in the operation cavity 115, and the handle operating member 122 extends from the bottom of the handle base 110 to the outside of the operation cavity 115. A guide sleeve 113 (see FIG. 1C) serving as a guide structure is provided on an outer side of the bottom of the handle base 110, the first pushing member 130 is at least partially accommodated in the guide sleeve 113 and is guided by in a form-fit manner with the guide sleeve 113, so as to be movable toward and away from the handle body 125 in the first direction X. The first pushing member 130 can pass through a hole 116 in the handle base 110 into the operation cavity 115 to push the handle body 125, and can be withdrawn from the operation cavity 115.

The second pushing member 140 is drivingly connected with an output end 185 of the driving device 180, and is moved forward and backward in a second direction Y under the drive of the driving device 180. The second direction Y is perpendicular to the first direction X. The second pushing member 140 includes a front actuating portion 141 and a rear actuating portion 142. The front actuating portion 141 is further away from the axis A than the rear actuating portion 142.

When the second pushing member 140 is moved forward in the second direction Y, the front actuating portion 141 can operatively engage with the first pushing member 130 and the rear actuating portion 142 can operatively engage with the handle operating member 122. Accordingly, the second pushing member 140 can drive the handle 120 to rotate from the retracted position to the intermediate position by means of the first pushing member 130, and can drive the handle 120 to rotate from the intermediate position to the deployed position by means of the handle operating member 122.

In this way, the second pushing member 140 can act on the handle 120 both in a first position farther from the axis A by means of the first pushing member 130 and in a second position closer to the axis A by means of the handle operating member 122. The second pushing member 140 acting on the handle 120 in the first position may perform an ice breaking operation, and acting on the handle 120 in the second position may perform a normal deployment operation on the handle.

In some embodiments, when the handle 120 is in its retracted position, the second direction Y is substantially parallel to a direction of extension of the handle body 125, and the first direction X is generally perpendicular to the direction of extension of the handle body 125.

The return spring 160 is for example a coil spring arranged to bias the first pushing member 130 in a direction away from an initial position of the handle body 125. When the first pushing member 130 is pushed by the second pushing member 140 to move toward the handle body 125, the return spring 160 is compressed. When the first pushing member 130 is released by the second pushing member 140, the return spring 160 pushes the first pushing member 130 to move away from the handle body 125 by a restoring force such that the first pushing member 130 can move out of the operation cavity 115 of the handle base 110 after the ice breaking operation of the handle 120 has been completed.

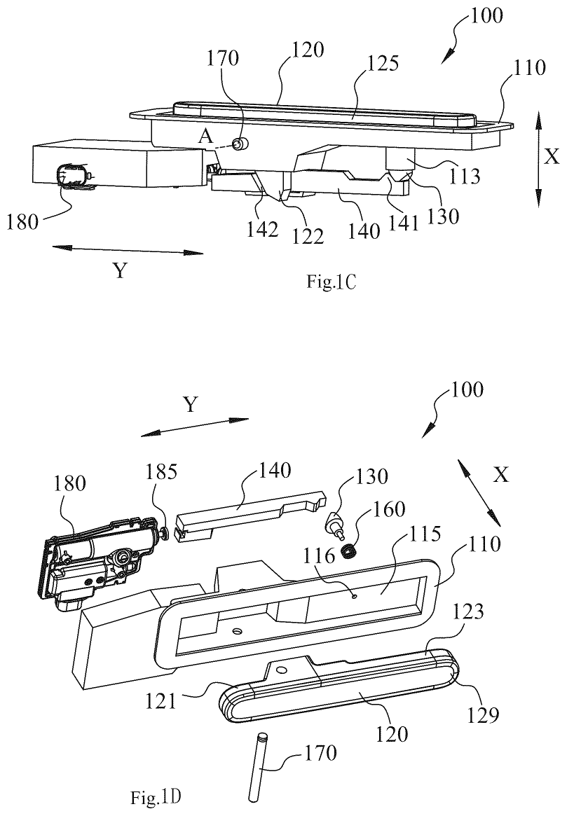

FIG. 2 is a perspective view of the handle 120. As shown in FIG. 2, the handle operating member 122 of the handle 120 is relatively close to the axis A, near the proximal end 121 of the handle 120, and remote from the distal end 129 of the handle body 120. The handle operating member 122 is a protruding block, which extends from the handle body 125, and on which a rear actuated surface 230 is provided. The rear actuated surface 230 is an inclined surface inclined relative to the second direction Y.

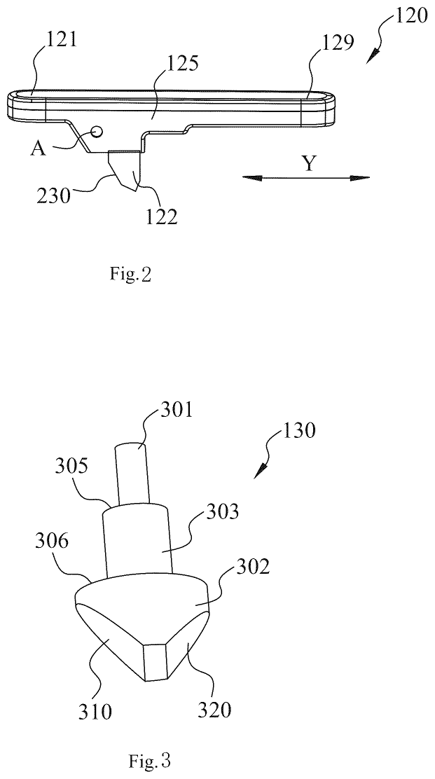

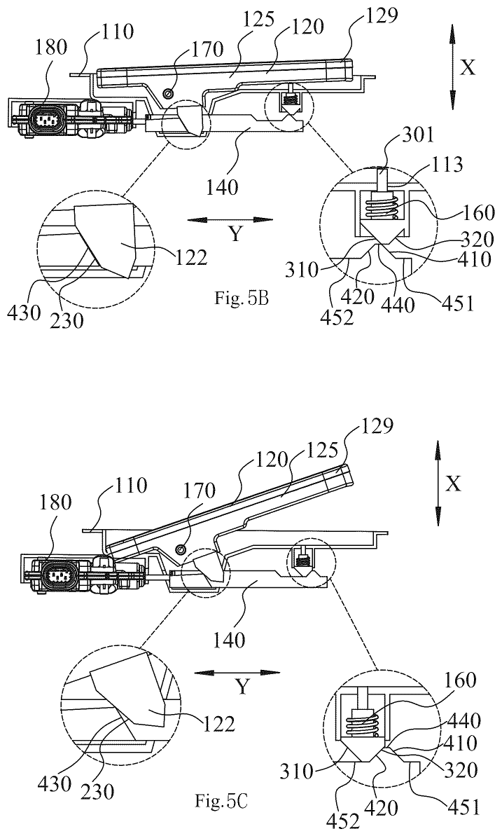

FIG. 3 shows the specific structure of the first pushing member 130 in a perspective view. As shown in FIG. 3, the first pushing member 130 is generally rod-shaped and includes a head 301 and a tail 302 opposite to each other. The head 301 has a relatively small diameter and can pass through the hole 116 of the handle base 110. The diameter of the tail 302 is relatively large, and is slightly smaller than the inner diameter of the guide sleeve 113 of the handle base 113. With the form fit between the tail 302 of the first pushing member 130 and the guide sleeve 113, the first pushing member 130 is guided by the guide sleeve 113 to move in the first direction X. The first pushing member 130 further includes a body 303 between the head 301 and the tail 302. The diameter of the body 303 is larger than the diameter of the head 301 and smaller than the diameter of the tail 302. A limiting surface 305 is formed between the body 303 and the head 301 for cooperating with the handle base 110 to limit a distance by which the first pushing member 130 moves toward the handle body 125. A retaining surface 306 is formed between the tail 302 and the body 303 for retaining the return spring 160 such that the return spring 160 is retained between the retaining surface 306 and the handle base 110 (see FIG. 5A).

Still referring to FIG. 3, the tail 302 of the first pushing member 130 is operatively engaged with the front actuating portion 141 of the second pushing member 140 such that the first pushing member 130 can be driven by the front actuating portion 141 to move toward the handle 120 when the second pushing member 140 is moved both forward and backward in the second direction Y. To this end, the tail 302 of the first pushing member 130 is provided with a first front actuated surface 310 and a second front actuated surface 320. The first front actuated surface 310 is configured to engage with the front actuating portion 141 of the second pushing member 140 when the second pushing member 140 is moved forward in the second direction Y, and the second front actuated surface 320 is configured to engage with the front actuating portion 141 of the second pushing member 140 when the second pushing member 140 is moved backward in the second direction Y. In the illustrated embodiment, the first front actuated surface 310 and the second front actuated surface 320 are inclined surfaces extending obliquely relative to the second direction Y and are inclined oppositely to each other. In other embodiments, the first front actuated surface 310 and the second front actuated surface 320 may also be not inclined surfaces, but other types of surfaces (e.g., cam surfaces).

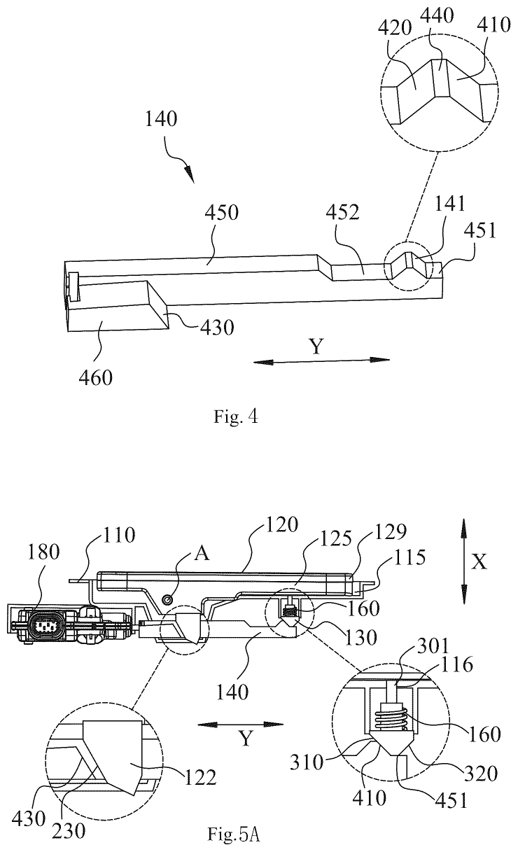

FIG. 4 shows the specific structure of the second pushing member 140 in a perspective view. As shown in FIG. 4, the second pushing member 140 includes an elongated main body 450 extending in the second direction Y, and an additional block 460 disposed on one side of the main body 450.

The front actuating portion 141 is provided on the main body 450, the rear actuating portion 142 is provided on the additional block 460, and the front actuating portion 141 and the rear actuating portion 142 are provided at different positions (i.e., the first position and the second position) of the second pushing member 140 in the second direction Y. The main body 450 is further provided with a front support surface 451 and a rear support surface 452 provided before and behind the front actuating portion 141, respectively. The front actuating portion 141 is raised relative to the front support surface 451 and the rear support surface 452. The front support surface 451 and the rear support surface 452 are planar surfaces that are substantially parallel to the second direction Y. When the handle 120 is in its retracted position, the first pushing member 130 is supported by the front support surface 451. When handle 120 is in its deployed position, the first pushing member 130 is supported by the rear support surface 452.

The front actuating portion 141 includes a first front actuating surface 410 and a second front actuating surface 420 which are connected to the front support surface 451 and the rear support surface 452, respectively. The first front actuating surface 410 and the second front actuating surface 420 are configured to operatively engage with the first front actuated surface 310 and the second front actuated surface 320 of the first pushing member 130, respectively. The first front actuating surface 410 and the second front actuating surface 420 are inclined surfaces extending obliquely relative to the second direction Y, and are inclined oppositely to each other. The front actuating portion 141 further includes a transition surface 440 for connecting the first front actuating surface 410 and the second front actuating surface 420. The transition surface 440 is located at the top of the front actuating portion 141, and is a planar surface that is substantially parallel to the second direction Y.

The rear actuating portion 142 includes a rear actuating surface 430 configured to operatively engage with the rear actuated surface 230 of the handle operating member 122. The rear actuating surface 430 is an inclined surface extending obliquely relative to the second direction Y.

In other embodiments, the first front actuating surface 410, the second front actuating surface 420, and the rear actuating surface 430 may also be not inclined surfaces, but other types of surfaces (e.g., cam surfaces).

In some embodiments, the first front actuating surface 410, the second front actuating surface 420, and the rear actuating surface 430 may be shaped to match the first front actuated surface 310, the second front actuated surface 320, and the rear actuated surface 230, respectively, for example, they have substantially the same slope.

FIGS. 5A to 5C show a process of rotation of the handle device 100 from the retracted position to the deployed position. FIG. 5A is a side view of the handle device 100 when the handle is in the retracted position, FIG. 5B is a side view of the handle device 100 when the handle is in the intermediate position, and FIG. 5C is a side view of the handle device 100 when the handle is in the deployed position. Part of the handle base 110 has been cut away in FIGS. 5A to 5C to expose the components accommodated in the handle base 110.

As shown in FIG. 5A, when the handle 120 is in the retracted position, the first front actuated surface 310 of the first pushing member 130 abuts against the first front actuating surface 410 of the second pushing member 140, and the head 301 of the first pushing member 130 is partially located in the hole 116 of the handle base 110. The first pushing member 130 is supported by the front support surface 451 of the second pushing member 140 to retain the first pushing member 130 between the second pushing member 140 and the handle base 110. As can be seen in FIG. 5A, the first pushing member 130 is at a relatively long distance from the axis A. In addition, the rear actuating surface 430 of the second pushing member 140 is at a certain distance from the rear actuated surface 230 of the handle operating member 122, and does not contact the rear actuated surface 230.

When the handle device 100 in the state shown in FIG. 5A is driven by the driving device 180, the second pushing member 140 moves forward in the second direction Y (i.e., moving rightward in FIG. 5A), and the second pushing member 140 pushes the first pushing member 130, by means of its first front actuating surface 410, to move in the first direction X toward the handle 120 (i.e., moving upward in FIG. 5A), so that the first pushing member 130 pushes the handle 120, by means of its head 301, to rotate about the axis A from the retracted position to the intermediate position (as shown in FIG. 5B).

As shown in FIG. 5B, when the handle 120 is in the intermediate position, the first actuated surface 310 thereof is to disengage from the first front actuating surface 410 of the second pushing member 140 because the first pushing member 130 has moved upward, and the head 310 of the first pushing member 130 extends from the hole 116 into the operation cavity 115 of the handle base 110. In addition, the rear actuating surface 430 of the second pushing member 140 is in contact with or in proximity to the rear actuated surface 230 of the handle operating member 122. When the handle 120 is in the intermediate position, the distal end 129 of the handle 120 is slightly deployed outward (or extends out) compared to the retracted position shown in FIG. 5A, which indicates that the handle 120 has broken ice, and the handle 120 is separated from the outer surface 195 of the door. During movement from FIG. 5A to FIG. 5B, the first pushing member 130 compresses the return spring 160.

When the driving device 180 of the handle device 100 in the state shown in FIG. 5B continues to operate, it drives the second pushing member 140 to continue to move forward in the second direction Y, so that the second pushing member 140 pushes the rear actuated surface 230 of the handle 120 by means of the rear actuating surface 430, thereby pushing the handle 120 to rotate about the axis A from the intermediate position to the deployed position. During this process, the first pushing member 130 passes over the transition surface 440 of the front actuating portion of the second pushing member 140 and moves away from the handle in the first direction X (i.e., moving downward in FIG. 5B) under the restoring force of the return spring 160, until the first pushing member 130 comes into contact with and is supported by the rear support surface 452, that is, reaching the deployed state shown in FIG. 5C. During this process, the second front actuating surface 420 of the second pushing member 140 can cooperate with the second front actuated surface 320 of the first pushing member 130 to guide the downward movement of the first pushing member 130.

When it is required to return the handle 120 from the deployed position shown in FIG. 5C to the retracted position shown in FIG. 5A, the second pushing member 140 may be driven in reverse by the driving device 180 to move backward in the second direction Y. During this process, the second pushing member 140 can push the first pushing member 130 to move toward the handle body 125 again in the first direction X by operatively engaging the second front actuating surface 420 of the second pushing member 140 with the second front actuated surface 320 of the first pushing member 130, so that the first pushing member 130 can pass over the transition surface 440 and re-enter into the state of engagement with the first front actuating surface 410, thereby returning to the initial position shown in FIG. 5A.

When the handle in the retracted position is frozen, the perimeter of the handle is frozen and joined to the outer surface of the door. The inventors of the present disclosure have found that the distal end of the handle is generally the first and most easily protruding portion the handle from a vehicle body. Therefore, when it is required to deploy the handle to break ice, overcoming the resistance at the distal end of the handle becomes the primary objective. According to the lever principle, when it is required to rotate the handle about the axis against the resistance at the distal end, the farther the position where the deployment force is applied to the handle from the axis, the smaller the deployment force is required.

Therefore, in the present disclosure, by providing the first pushing member pushed by the second pushing member and having the first pushing member act on the handle at a position farther from its axis, the handle can be pushed to break ice with a relatively small force, to separate the distal end of the handle from the outer surface of the door. In this way, given a constant power of the driving device used, the handle device of the present disclosure can more easily achieve the ice breaking operation. In addition, by being providing with two pushing members cooperating with each other, the handle device of the present disclosure has a relatively high force transmission efficiency during the ice breaking operation, thereby facilitating the ice breaking operation. In addition, the handle device of the present disclosure can perform the operation of deploying the handle by pushing the handle operating member near the axis of the handle only after performing the ice breaking operation, so that it is possible to reduce the additional consumption of power of the driving device during the ice breaking operation, thereby further making the ice breaking operation easier.

Furthermore, the present disclosure makes it possible to withdraw the first pushing member from the operation cavity of the handle after the handle reaches the deployed position by providing mutually cooperating structures on the first pushing member and the second pushing member, to prevent the first pushing member from affecting the operator's operation.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

Reference signs:

| | |
|---|---|
| handle device | 100 |
| handle base | 110 |
| guide sleeve | 113 |
| operation cavity | 115 |
| hole | 116 |
| handle | 120 |
| handle operating member | 122 |
| handle body | 125 |
| proximal end | 121 |
| distal end | 129 |
| first pushing member | 130 |
| second pushing member | 140 |
| front actuating portion | 141 |
| rear actuating portion | 142 |
| return spring | 160 |
| shaft | 170 |
| driving device | 180 |
| output end | 185 |
| vehicle | 190 |
| door | 192 |
| outer surface | 195 |
| rear actuated surface | 230 |
| head | 301 |
| tail | 302 |
| body | 303 |
| limiting surface | 305 |
| retaining surface | 306 |
| first front actuated surface | 310 |
| second front actuated surface | 320 |
| first front actuating surface | 410 |
| second front actuating surface | 420 |
| main body | 450 |
| additional block | 460 |
| front support surface | 451 |
| rear support surface | 452 |
| rear actuating surface | 430 |

What is claimed is:

1. A handle device, comprising:
a handle base;
a handle comprising a handle body and a handle operating member extending from the handle body, the handle being rotatably connected to the handle base about an axis so as to switch between a retracted position, a deployed position, and an intermediate position between the retracted position and the deployed position;
a first pushing member movable toward and away from the handle body in a first direction; and
a second pushing member configured to move forward and backward in a second direction under the drive of a driving device, the second pushing member comprising a front actuating portion and a rear actuating portion, the front actuating portion being further away from the axis than the rear actuating portion,
wherein the second pushing member is configured such that during a forward movement in the second direction, the second pushing member operatively engages with the first pushing member through the front actuating portion so as to drive the handle to rotate from the retracted position to the intermediate position by means of the first pushing member, and operatively engages with the handle operating member through the rear actuating portion so as to drive the handle to rotate from the intermediate position to the deployed position by means of the handle operating member.

2. The handle device according to claim 1, wherein
the second pushing member comprises a front support surface and a rear support surface respectively positioned before and behind the front actuating portion in the second direction, wherein the first pushing member is supported by the front support surface when the handle is in its retracted position, and the first pushing member is supported by the rear support surface when the handle is in its deployed position.

3. The handle device according to claim 2, wherein
the front actuating portion and the first pushing member cooperate with each other by means of inclined surfaces such that the front actuating portion operatively engages with the first pushing member.

4. The handle device according to claim 3, wherein
the front actuating portion is raised relative to the front support surface and the rear support surface and comprises a first front actuating surface and a second front actuating surface respectively connected to the front support surface and the rear support surface, the first front actuating surface and the second front actuating surface extending obliquely relative to the second direction and being inclined oppositely to each other.

5. The handle device according to claim 4, wherein
the first pushing member comprises a first front actuated surface and a second front actuated surface, the first front actuated surface and the second front actuated surface extending obliquely relative to the second direction and being inclined oppositely to each other,
wherein the first front actuated surface cooperates with the first front actuating surface such that the second pushing member is capable of driving the first pushing member to move toward the handle body when moving forward in the second direction; and
wherein the second front actuated surface cooperates with the second front actuating surface such that the second pushing member is capable of driving the first pushing member to move toward the handle body when moving backward in the second direction.

6. The handle device according to claim 1, wherein
the rear actuating portion and the handle operating member cooperate with each other by means of inclined surfaces such that the rear actuating portion operatively engages with the handle operating member.

7. The handle device according to claim 6, wherein
the rear actuating portion comprises a rear actuating surface, and the handle operating member comprises a rear actuated surface, the rear actuating surface and the rear actuated surface extending obliquely relative to the second direction,
wherein the rear actuating surface cooperates with the rear actuated surface such that the second pushing member is capable of driving the handle operating member to rotate when moving forward in the second direction.

8. The handle device according to claim 2, wherein
the handle base comprises an operation cavity, the handle body is at least partially received in the operation cavity, and the handle operating member extends to the outside of the operation cavity,
wherein the second pushing member is located outside the operation cavity, the first pushing member is configured to enter the operation cavity when moving toward the handle body, and to move out of the operation cavity when the handle reaches the deployed position.

9. The handle device according to claim 8, wherein
the handle base is provided with a guide structure, and the first pushing member is guided by the guide structure to move in the first direction.

10. The handle device according to claim 9, wherein
the guide structure comprises a guide sleeve positioned outside the operation cavity, and the first pushing member is at least partially accommodated in the guide sleeve and is guided in a form-fit manner with the guide sleeve.

11. The handle device according to claim 8, wherein
the first pushing member is provided with a limiting surface, the limiting surface being configured to cooperate with the handle base to limit a distance by which the first pushing member moves toward the handle body.

12. The handle device according to claim 8, further comprising:
a return spring configured to bias the first pushing member in a direction away from the handle body.

13. The handle device according to claim 12, wherein
the first pushing member is provided with a retaining surface, the retaining surface being configured to cooperate with the handle base to retain the return spring between the retaining surface and the handle base.

14. The handle device according to claim 1, wherein
the second direction is perpendicular to the first direction.

15. A vehicle, comprising the handle device according to any one of claim 1.
